(19) United States
(12) Patent Application Publication
(10) Pub. No.: US 2001/0013883 A1
(43) Pub. Date: Aug. 16, 2001

(54) Image-forming apparatus

(76) Inventors: Ken Tanino, Osaka (JP); Yasuhiro Ohno, Osaka (JP); Toshiya Natsuhara, Takarazuka-Shi (JP)

Correspondence Address: BURNS DOANE SWECKER & MATHIS L L P, POST OFFICE BOX 1404, ALEXANDRIA, VA, 22313-1404, US

(21) Appl. No.: 09/739,632

(22) Filed: Dec. 20, 2000

(30) Foreign Application Priority Data
Dec. 21, 1999 (JP) 11-362629/1999

(51) Int. Cl. B41J 2/06

(52) U.S. Cl. 347/55

(57) ABSTRACT

The object of the present invention is to provide an image-forming apparatus which does not cause a clogging of the apertures for a long time and supplies a sharp image.

The present invention provides an image-forming apparatus which comprises

(i) a toner-supporting member which supports and conveys a toner,

(ii) a back electrode which is arranged on the opposite side of the toner-supporting member at a predetermined interval,

(iii) a head equipped with a plural aperture and a recording electrode which is arranged in such a way that it surrounds each aperture, said head being arranged between the toner-supporting member and the back electrode, and

(iv) a driver which applies a voltage to the recording electrode in response to an image signal and which causes the toner supported on the toner-supporting member to adhere jettingly to a recording medium through the apertures,

wherein an opening ratio of the apertures is 40-95% when the toner is jettingly adhered to the recording medium 20 times.

This application is based on an application No. 362629/1999 filed in Japan, the contents of which are hereby incorporated by reference.

### BACKGROUND OF THE INVENTION

1. Field of the Invention

The present invention relates to an image-forming apparatus which employs a toner-jetting system wherein a toner-supporting member and a recording medium such as paper are maintained in a non-contact state, and a charged toner from the toner-supporting member is jettingly adhered to the recording medium in a direct manner to form the image.

2. Description of the Related Art

An image-forming apparatus which employs the toner-jetting system (direct recording method) has formerly been known in which a head having a plural aperture is oppositely arranged to the toner-supporting member and a voltage corresponding to an image signal is applied to a recording electrode which is arranged around the periphery of each aperture so that an electrostatic force is exerted on the toner, and in which the toner from the toner-supporting member is jettingly adhered to the recording member through the apertures.

However, in such an image-forming apparatus, there are problems that the apertures are clogged as the toner is jettingly flied through the apertures and the desired image cannot be obtained and that an edge part of the image (a boundary part between the image and a substrate) becomes unsharp even if the desired image can be obtained.

Although an attempt has formerly been made in which a specific toner is used in order to keep an opening ratio of the aperture in 100% at all times, the aforesaid problems are not thoroughly solved under the present situation.

### SUMMARY OF THE INVENTION

The present invention has been made in view of the aforementioned situation, and its object is to provide an image-forming apparatus which does not cause the clogging of the apertures for a long time and supplies a sharp image.

The present inventors has paid our attention to an opening ratio of the aperture, particularly an opening ratio of the aperture when the toner is jettingly adhered to the recording medium 20 times in the image-forming apparatus which employs the toner-jetting system, and has found out that the clogging of the aperture is caused at the time of plate wearing when said value is too small, while the edge of the obtained image becomes unsharp when said value is too large.

The present invention relates to an image-forming apparatus which comprises

(i) a toner-supporting member which supports and conveys a toner,

(ii) a back electrode which is arranged on the opposite side of the toner-supporting member at a predetermined interval,

(iii) a head equipped with a plural aperture and a recording electrode which is arranged in such a way that it surrounds each aperture, said head being arranged between the toner-supporting member and the back electrode, and

(iv) a driver which applies a voltage to the recording electrode in response to an image signal and which causes the toner supported on the toner-supporting member to adhere jettingly to a recording medium through the apertures,

wherein an opening ratio of the apertures is 40-95% when the toner is jettingly adhered to the recording medium 20 times.

### BRIEF DESCRIPTION OF THE DRAWINGS

FIG. 1 is a schematic view showing one example of the image-forming apparatus according to the present invention.

FIG. 2 is a schematic enlarged view of a printing area of the apparatus shown in FIG. 1.

FIG. 3 is a schematic perspective view showing a positional relationship among one aperture, a trigger electrode and a guarded electrode when the aperture is observed from a side of a driving roller in FIG. 2.

FIG. 4 is a schematic view showing one example of an apparatus for thermal treatment of a toner.

FIG. 5 is a schematic enlarged view showing an area of from a sleeve to a back electrode, said view being utilized for indicating a mechanical setting condition of the apparatus shown in FIG. 1.

### DETAILED DESCRIPTION OF THE INVENTION

The image-forming apparatus according to the present invention comprises at least (i) the toner-supporting member which supports and conveys the toner, (ii) the head arranged on the opposite side of the toner-supporting member, said head having a plural aperture on its opposite part to the toner-supporting member, and (iii) the recording electrode arranged on the head in such a way that it surrounds each aperture. In the apparatus, the image is formed on the recording medium by applying the voltage which corresponds to the image signal to the recording electrode and causing the toner supported on the toner-supporting member to fly jettingly through the apertures in accordance with the applied voltage.

In the case of the image-forming apparatus according to the present invention, the opening ratio of the apertures when the toner is jettingly adhered to the recording medium 20 times is 40-95%, preferably 60-90%, more preferably 70-90%. When the opening ratio exceeds 95%, the edge parts of the obtained image becomes unsharp. In an excellent stationary state concerning a jetting flight of the toner, (i) a certain amount of the toner adheres on inner walls of the apertures, (ii) some of the flown toner pass through the apertures without adhering on the inner walls of the apertures, (iii) some of the flown toner adhere on the inner walls of the apertures, and (iv) some of the toner adhered on the inner walls of the apertures fly jettingly again toward the recording medium. It is thinkable that sharp images can be obtained without causing the clogging of the apertures by carrying out a printing while a certain balance is kept as mentioned above. However, when the amounts of the toner adhered on the inner walls of the apertures become too small, i.e. when the aforementioned opening ratio exceeds 95%, the toner exists sparsely on the inner walls of the apertures. Therefore it is thinkable that the obtained images become unsharp because, for example, the toner which is expected to adhere on the inner walls of the apertures is repelled even if said toner comes into collision with the inner walls of the apertures, and said toner passes through the apertures without being adhered to the inner walls of the apertures to bring about a loss of the aforesaid balance which exerts a bad influence upon a flight amount and a flight direction of the toner. On the other hand, when the opening ratio becomes less than 40%, the toner is adhered to the inner walls of the apertures by the subsequent printing, and the clogging of the apertures will occur consequently.

Unless otherwise indicated, the opening ratio of the aperture used in the present specification means the opening ratio of the aperture when the toner is jettingly adhered to the recording medium 20 times. More particularly, said opening ratio is the ratio of “an opening area of an unused aperture” to “an opening area of the aperture when the toner is jettingly adhered to the recording medium 20 times”. In the case where the opening ratio of the aperture when the toner is jettingly adhered to the recording medium 20 times is fallen within the aforementioned range, said opening ratio is stationarily kept when the subsequent printing is carried out, and sharp images can be outputted without causing the problem of the clogging of the apertures over a relatively long time. The conditions wherein the opening ratio is measured are the same as the setting conditions employed when the image-forming apparatus is used (e.g. an electrical condition, a mechanical condition and a toner condition).

The object of the present invention can more effectively achieved by setting the opening ratio within the aforementioned preferable range or more preferable range.

In the present invention, any conditions of the various setting conditions of the image-forming apparatus (e.g. the electrical condition, the mechanical condition, the toner condition and the like) may be employed provided that the opening ratio when the toner is jettingly adhered to the recording medium 20 times is fallen within the aforementioned range.

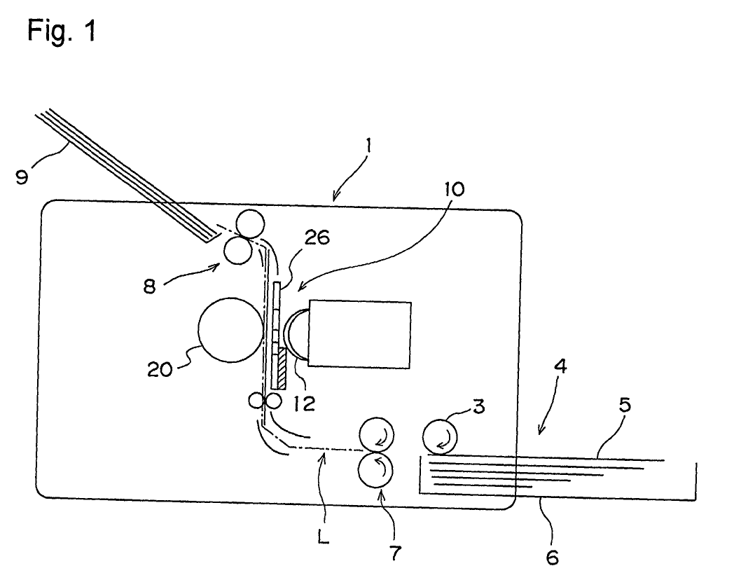

The preferred embodiment of the image-forming apparatus according to the present invention will be explained hereinafter. The image-forming apparatus according to the present invention has usually the construction as shown in FIG. 1. FIG. 1 shows a diagramatic construction of one preferred embodiment of the image-forming apparatus (the printing apparatus) according to the present invention, said apparatus being indicated by the number 1. The printing apparatus 1 has a sheet-feed station indicated wholly by the number 4. The sheet-feed station 4 has a cassette 6 wherein sheets 5, such as papers and the like are received in a laminated state. A sheet-feeding roller 3 arranged above the cassette 6 rotates while it contacts with the uppermost sheet 5 to send the sheet 5 to an inside of the printing apparatus 1. In the neighborhood of the sheet-feeding roller 3, a pair of timing rollers 7 is arranged. The timing rollers supply the sheet 5 that has been sent from the cassette 6 to an image-forming part (the whole thereof is shown by the number 10), in which an image made of a printing material is formed on the sheet 5, along a passageway L for a sheet shown by a dotted line. Further, the printing apparatus 1 has a back roller 20 for guiding the flying toner particles which is opposite to the image-forming part 10. In the image-forming part 10, the toner-supporting member 12 which supports and conveys the toner and the head 26 having a plural aperture on its opposite side to the toner-supporting member are arranged, said head being situated on the opposite side of the toner-supporting member. Furthermore, the printing apparatus 1 has a fixing station 8 for permanently fixing the image made of the printing material on the sheet 5 and a final stack station 9 for receiving the sheet 5 on which the image made of the printing material has been fixed.

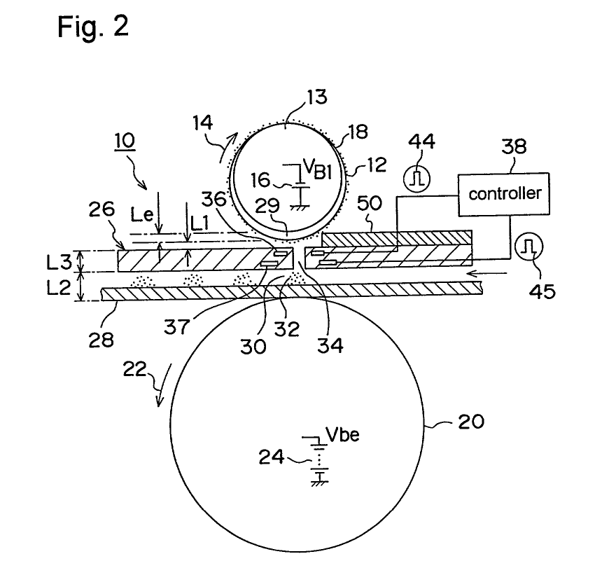

In order to indicate a detailed construction of a region ranging from the toner-supporting member 12 to the back roller 20, a schematic enlarged view of said region is shown in FIG. 2. The image-forming part 10 is equipped with the driving roller 13. The driving roller 13 is formed of a cylindrical roller made of a conductive material (e.g. SK steel, aluminum, stainless steel and the like) or a metallic roller whose outside peripheral surface is coated with a conductive elastic material (e.g. nitrile rubber, silicone rubber, styrene rubber, butadiene rubber, urethane rubber and the like). The driving roller 13 can rotatably be driven toward the direction of the arrow 14 by a motor (not shown). Furthermore, the driving roller 13 is connected to the first bias power source 16, and a prescribed voltage can be applied to said roller (the bias voltage V_{B1} having negative polarity is applied in the present embodiment). The driving roller 13 is sheathed with the toner-supporting member which supports and conveys the toner (hereinafter referred to as a sleeve) 12. The toner 18 charged with electricity having a prescribed polarity (negative polarity in the present embodiment) is supported on a surface of an external periphery of the sleeve 12 while said toner forms a layer thereof on said surface.

The sleeve 12 is a cylindrical sleeve formed from a thin film which may contain a conductive material, for example, a flexible resin sheet made of resin, such as polycarbonate, nylon, fluororesin and the like, a sheet prepared by adding carbon, whisker, metallic powder and the like to the abovementioned resins, a metallic thin film made of nickel, stainless steel, aluminum and the like, or a sheet prepared by laminating the abovementioned resin sheet and the metallic thin film. An inner diameter of the sleeve is slightly larger than an outer diameter of the driving roller 13. On the both ends concerning a rotating shaft of the sleeve 12, an upper part of the sleeve shown in FIG. 2 is pressed against the driving roller 13 by a pressing member (not shown), and a lower part (a free part 29) of the sleeve shown in FIG. 2 can be rotated toward the direction of the arrow 14 by a friction with the driving roller 13 depending on the rotation of the driving roller 13 while said lower part is kept in a noncontact state with the driving roller 13.

In the neighborhood of the driving roller 13, the back electrode roller (back electrode) 20 is arranged parallel to the driving roller 13 and the sleeve 12, said back electrode roller being arranged on the opposite side of the free part 29 of the sleeve 12. The back electrode roller 20 may be composed of a conductive material (e.g. SK steel, aluminum, stainless steel and the like). Alternatively, the back electrode roller 20 may be a roller obtained by coating the outside peripheral surface of a metallic roller with a conductive elastic material (e.g. nitrile rubber, silicone rubber, styrene rubber, butadiene rubber, urethane rubber and the like) or a dielectric material (e.g. dielectric resin, dielectric rubber and the like). The back electrode roller 20 is supported in such a way that it can rotate toward the direction of the arrow 22. Furthermore, the back electrode roller 20 is connected to the second bias electric source 24, and the prescribed voltage which is a bias voltage Vbe having positive polarity in the present embodiment is applied to the back electrode roller 20. Although the negatively charged toner 18 supported on the sleeve 12 is attracted toward the back electrode roller 20 by an electric field between the driving roller 13 and the back electrode roller 20 which is caused by a potential difference between these rollers, the bias voltage V_{B1} and Vbe are controlled in such a way that the developer 18 cannot be separated from the sleeve 12 by only the attraction force. In a general way, the bias voltage Vbe is a voltage having a counter polarity to the toner, and an absolute value thereof is usually 450-800V, preferably 550-750V.

The head 26 is arranged between the sleeve 12 and the back electrode roller 20. The space (L1) between the sleeve 12 and the head 26 is set at a constant interval. On the other hand, the space (L2) between the back electrode roller 20 and the head 26 is setted in such a way that the recording medium (e.g. paper, resin film and the like) can pass through said space (L2) and the space 30 is formed in which the toner 18 adhered to the recording medium 28 cannot contact the head 26. In general, the space (L1) is suitably set within the range of 10-100 μm, and the space is suitably set within the range of 100-250 μ. A suitable thickness (L3) of the head is 50-120 μm.

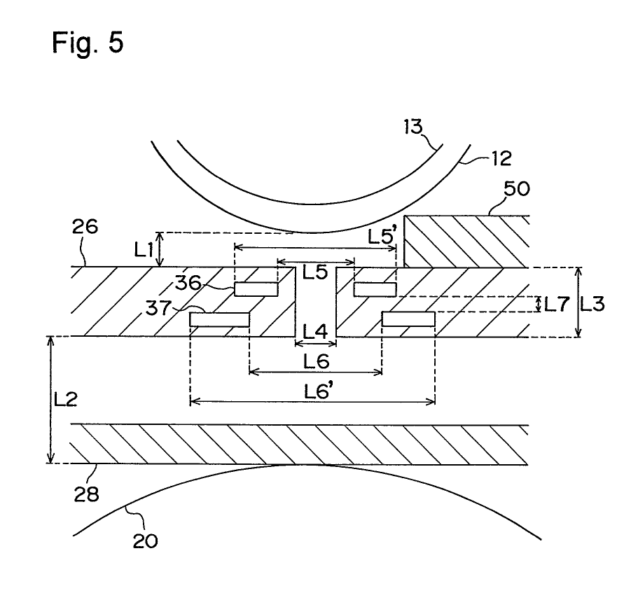

Although a flexible printing circuit-board is preferably used as the head 26, it is not limited to this circuit-board. A printing circuit formed on the rigid thin plate made of a nonconductive material (e.g. ceramic, glass, resin and the like) may be employed. As shown in FIG. 2, at a part of the head 26, i.e. a part included in an area (printing area 32) wherein the sleeve 12 is faced with the back electrode roller 20, a plural circular aperture (hole) 34 which penetrates the head 26 is formed at prescribed intervals on a line which is parallel with a central axis of the driving roller 13. This parallel direction is hereinafter referred to as the direction A. Alternatively, the plural apertures may be formed at prescribed intervals along the plural lines which are parallel with the axis of the driving roller 13. Although a diameter 14 of the aperture (see FIG. 5 which is a schematic enlarged view showing an area of from a sleeve to a back electrode) is not particularly restricted because it is necessary to set said diameter in consideration of a relationship to a particle size of the toner, said diameter is usually set within the range of 60-140 μm, preferably 70-120 μm, more preferably 80-100 μm.

The recording electrodes are arranged on the head 26 in such a way that said electrodes surround each aperture. More particularly, as shown in FIG. 2, the ringed trigger electrode 36 is arranged on the side of the driving roller in the inside of the head 26 in such a way that said trigger electrode surrounds each aperture 34. On the other hand, the ringed guarded electrode 37 is arranged on the side of the back electrode 20 in the inside of the head 26 in such a way that said guarded electrode surrounds each aperture 34 and has an inner diameter which is larger than that of the ringed trigger electrode 36. Although the trigger electrode 36 and the guarded electrode 37 are arranged in FIG. 2 in such a manner that both electrodes are embedded in the inside of the head 26, they may be arranged on the surface of the head 26. In other words, the trigger electrode 36 may be arranged on the surface of the head 26 situated on the side of the driving roller, and the guarded electrode 37 may be arranged on the surface of the head 26 situated on the side of the back electrode 20.

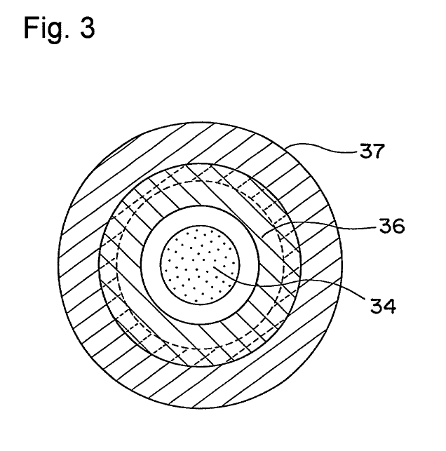

One example of the setting embodiments of the trigger electrode 36 and the guarded electrode 37 will be explained on the basis of FIG. 3 which is a schematic perspective view showing a positional relationship among one aperture 34, the trigger electrode 36 and the guarded electrode 37, when the aperture is observed from the side of the driving roller 13 in FIG. 2. In FIG. 3, the ringed trigger electrode 36 is arranged around the aperture 34, and the guarded electrode 37 is arranged around the aperture 34, said guarded electrode having the inner diameter which is larger than that of the trigger electrode. Although the trigger electrode 36 and the guarded electrode 37 are continuous in the peripheral direction in FIG. 3, the shapes of these electrodes are not restricted to this embodiment. For example, they may have a horseshoe shape in which a part of the electrodes is eliminated or a similar shape thereof.

The inner diameter (L5)(see FIG. 5; and so forth) of the trigger electrode 36 is larger than the diameter of the aperture. A suitable inner diameter of the trigger electrode 36 is usually 100-150 μm. The outer diameter (L5′) of the trigger electrode 36 is not particularly restricted and is usually 180-260 μm. From the viewpoints of a distribution of electrical field for flying the toner and a processability of FPC, it is preferable to set the inner diameter (L6) of the guarded electrode 37 in such a way that said inner diameter is larger than the inner diameter (L5) of the trigger electrode 36. A suitable inner diameter (L6) is usually 120-160 μm. The outer diameter (L6′) of the guarded electrode 37 is not particularly restricted and is usually 200-280 μm. The space (L7) between the trigger electrode 36 and the guarded electrode 37 measured in the direction of a thickness of the head 26 is not less than 30 μm.

The aforementioned trigger electrode 36 and guarded electrode 37 are connected to the controller (image-controlling part) 38 from which a printing signal corresponding to an image signal, i.e. the pulse voltage 44 and 45 can be applied to each trigger electrode 36 and each guarded electrode 37. Although, as mentioned above, the toner on the sleeve 12 is controlled in such a manner that said toner is attracted toward the back electrode roller 20 by the electrical field between the driving roller 13 and the back electrode roller 20 which is generated on the basis of the potential difference between the bias voltage V_{B1} and Vbe and that said toner is not separated from the sleeve 12 by only the attraction force, a jetting flight of the toner supported on the sleeve 12 is started by an additional application of the aforesaid pulse voltage 44.

To say more precisely, a composite voltage (pulse voltage) 44 which comprises a direct current voltage (Vw) outputted at the time of nonprinting and a direct current voltage (Vb) outputted at the time of printing is applied to the trigger electrode 36. In the present embodiment, the direct current voltage Vw and Vb are set to a negative polarity and a positive polarity respectively. Therefore, in the case where the voltage Vw is applied to the trigger electrode 36, a group of the negatively charged toner which exists in the place situated on the opposite side of the trigger electrode 36 on the sleeve 12 electrically repels the trigger electrode 36 to which the voltage Vw having a negative polarity is applied and remains on the sleeve 12. On the other hand, when the voltage Vb is applied to the trigger electrode 36, an electrical field which is stronger than the electrical field generated previously on the basis of the potential difference between the bias voltage V_{B1} and Vbe is generated, and the group of the negatively charged toner is electrically attracted to the trigger electrode 36 to which the voltage Vb having a positive polarity is applied, and said group of the negatively charged toner is activated and jettingly flies from the sleeve toward the aperture.

As regards the trigger electrode, Vw is generally a voltage having the same polarity as the toner has or is 0V. A suitable absolute value of Vw is usually 0-100V, preferably 0-50V, more preferably 0-15V. In general, Vb is a voltage having an opposite polarity relative to the toner and a suitable absolute value of Vb is 400-850V, preferably 550-750V.

A composite voltage (pulse voltage) 45 which comprises a direct current voltage (Vgw) outputted at the time of nonprinting and a direct current voltage (Vg) outputted at the time of printing is applied to the guarded electrode 37. In general, a voltage having an opposite polarity relative to the toner is applied as the voltage Vg of the guarded electrode, Vgw is a voltage having an opposite or same polarity relative to the toner or is 0V. When Vgw has an opposite polarity relative to the toner, a voltage is applied which satisfies the following condition:

|Vg|>|Vgw|

said voltage ensuring an excellent balance among a diameter of a dot, a scattering of the toner, a flying amount of the toner and a sharpness of the edge. When the absolute value of Vg becomes smaller, although a converging effect is increased (i.e. the diameter of the dot becomes smaller) to decrease the scattering of the toner, an assisting effect of flying the toner toward the paper is decreased to reduce the flying amount of the toner, and the sharpness of the edge is decreased. On the other hand, when the absolute value of Vg becomes larger, although the converging effect is decreased (i.e. the diameter of the dot becomes larger) to increase the scattering of the toner, an electrical field is generated which assists the flight of the toner toward the paper to increase the flying amount of the toner, and an apparent sharpness of the edge is increased.

To say more precisely, in the case where the toner is negatively charged, a suitable Vgw of the guarded electrode is usually −110-50V, preferably −50-0V, and a suitable Vg is usually 50-350V, preferably 100-200V. In the case where the toner is positively charged, suitable Vgw and Vg are fallen within the aforesaid ranges in which negative and positive polarities are reversed. According to the present invention, it is not necessarily to arrange the guarded electrode.

The controller 38 comprises (i) a controlling part for the trigger electrode equipped with an output part of an image signal which outputs a signal corresponding to an image supplied by the image-forming apparatus and a pulse generator which generates the aforementioned pulse voltage for the trigger electrode in a constant period, and (ii) a controlling part for the guarded electrode equipped with an output part of an image signal which outputs a signal corresponding to the aforesaid image and a pulse generator which generates the aforementioned pulse voltage for the guarded electrode in a constant period. In any of the controlling part for the trigger electrode and the controlling part for the guarded electrode, the output parts of an image signal and an output part of each pulse generator are connected to the corresponding individual electrode by way of AND circuit and an amplifier. When each signal is outputted from the output parts of an image signal and the pulse generators, the pulses are amplified by means of the amplifier, and each of the amplified pulses is applied to the trigger electrode 36 or the guarded electrode 37.

According to the present invention, as shown in FIG. 2, it is preferable to arrange one platelike spacer 50 on the surface of the head 26 in an upper stream direction with respect to a rotating direction of the driving roller 13 and the sleeve 12 seen from the printing region 32, said surface being opposite to the sleeve 12. At least a part of end parts of the spacer 50 lightly contacts with the sleeve 12.

In general, in both end parts of the sleeve 12 and the driving roller 13 with respect to a rotating axis of the sleeve 12 (hereinafter referred to simply as the both end parts), an outer peripheral surface of the sleeve 12 is pressed against the driving roller 13 on the opposite side of the head 26 by means of each narrow pressing member or C-ringed member (not shown). By the action of the pressing member, a rotation of the driving roller 13 is transmitted to the sleeve 12 on the basis of a frictional force between the both while the driving roller 13 is in contact with the sleeve 12. In this rotation-transmitting mechanism, if the spacer 50 is not arranged, the height (Le) of the free part 29 between the sleeve 12 and the driving roller 13 becomes smaller because of an elastic recovery force of the sleeve 12, and the distance between the sleeve 12 and the trigger electrode 36 or the back electrode roller 20 is slightly changed with an approach from the both end parts of the sleeve 12 and the driving roller 13 toward the middle part with respect to the rotating axis of the sleeve 12 (hereinafter referred to simply as the middle part). Therefore there is a difference between the both end parts and the middle part of the sleeve 12 in relation to an attraction force which enlivens the toner 18 supported on the sleeve 12 toward the back electrode roller 20, with the result that a density of the image formed becomes thicker with the approach toward the both end parts of the sleeve 12 and the driving roller 13.

Accordingly the spacer 50 is not particularly restricted provided that it has a shape which keeps a value of the space Le constant independently of a region of the sleeve 12. For example, a spacer 50 having a constant thickness (from several micrometers to several tens micrometers) may slightly protrude toward the rotation direction of the sleeve 12 at a region which is opposite to a neighborhood of the both end parts of the sleeve 12 seen from a direction of the driving roller 13 and the sleeve 12. Alternatively, a thickness of the spacer 50 at the region which is opposite to a neighborhood of the both end parts of the sleeve 12 and the driving roller 13 may slightly be larger than a thickness of the spacer 50 at the region which is opposite to a neighborhood of the middle part of the sleeve 12 and the driving roller 13. In the case where the spacer 50 has any of the aforesaid shapes, the spacer 50 only slightly contacts with the outer peripheral surface of the sleeve 12 at the neighborhood of the middle part of the sleeve 12 and does not exert a pressing force on the sleeve 12, with the result that it does not change the shape of the sleeve 12. On the other hand, the spacer 50 exerts a pressing force toward a central direction of the driving roller 13 on the outer peripheral surface of the sleeve 12 to slightly widen the space L1 between the aperture 34 of the head 26 and the region on the outer periphery of the sleeve 12 which is opposite to said aperture because the spacer 50 slightly protrudes toward the moving direction of the outer periphery of the sleeve 12 or has a slightly larger thickness at the neighborhood of the both end parts of the sleeve 12. Accordingly, the space L1 between the aperture 34 of the head 26 and the region on the outer periphery of the sleeve 12 which is opposite to said aperture is equal independently of the both end parts and the middle part of the sleeve 12 and the driving roller 13.

Furthermore, the toner-supporting member may be a spongy resin layer having a constant thickness which is made of a conductive material and covers a curved surface of the driving roller in place of the sleeve. In such a case, although there is a tendency to change the image density even if the curved surface (i.e. the cylindrical sidewall) of the driving roller is covered with the resin layer having a constant thickness because the toner-supporting member becomes spindle-shaped with an approach toward the both end parts of said member and a distance between said member and the trigger electrode or the back electrode roller slightly changes, the outer periphery of the toner-supporting member may be pressed with a weak force by the adaptation of the opposite shape of the aforementioned spacer wherein the spacer slightly protrudes toward the rotation direction of the toner-supporting member at the region which is opposite to the neighborhood of the middle part of the toner-supporting member or the thickness of the spacer at the region which is opposite to the neighborhood of the middle part of the toner-supporting member is slightly larger than the thickness of the spacer at the region which is opposite to the neighborhood of the both end parts of the toner-supporting member.

An operational procedure for forming an image in the image-forming part of the image-forming apparatus having the aforementioned construction will be illustrated. Although the case where the toner has a negatively electrifiable property will be illustrated hereinafter, the toner may have a positively electrifiable property. A polarity of each voltage in the latter case is opposite to that in the former case. When the recording medium 28 is conveyed to the printing region 32 at the time of forming an image in the image-forming part 10, the pulse voltage is applied to the trigger electrode 36 and the guarded electrode 37 from the controller 38 in a synchronized manner with the recording medium 28 wherein the voltage (Vb) applied to the trigger electrode at the time of printing has a positive polartiy, and the voltage (Vg) applied to the guarded electrode at the time of printing has also a positive polarity.

As the result, a new electrical field is generated between the trigger electrode 36 and the region of the sleeve 12 which is opposite to said electrode, said electrical field accelerating the negatively charged toner 18 supported on said region of the sleeve 12 toward the back electrode roller 20. In cooperation with an electrical field which has previously been generated between the driving roller 13 and the back electrode roller 20 by the first and second bias electric sources 16, 24, the newly generated electrical field separates a group of the toner supported on the region of the sleeve 12 and flies the toner jettingly from the sleeve 12.

The group of the flied toner is passed through the corresponding aperture 34 and jetting adhered to a part of the recording medium which is opposite to said aperture 34 to form dots. A desired image is formed by a gathering of many dots formed in this manner. In the image-forming apparatus according to the present invention, as mentioned above, the opening ratio of each aperture is fallen within the aforesaid range when the toner is jettingly adhered to the recording medium 20 times, with the result that a smooth flight of the toner is continuously carried out thereafter, and sharp images are outputted without causing the problems such as the clogging of the apertures and the like.

The toner adhered on the recording medium 28 is conveyed to the fixing station 8 in the fixing process (see FIG. 1) together with the recording medium 28 and melted under heating in the fixing station 8 and then fixed on the recording medium 28.

In the aforesaid embodiment of the image-forming apparatus according to the present invention, although the sleeve which has the suitable free part on the head side of the driving roller and with which the driving roller is sheathed is employed as the toner-supporting member which supports and conveys the toner, a driving roller made of the conductive material may directly be used as the toner-supporting member.

Furthermore, although the toner particles are directly flied from the toner-supporting member toward the recording medium in the aforementioned embodiment, the present invention may adopt en embodiment wherein an intermediate roller is arranged between the toner-supporting member and the head, said intermediate roller being in contact with the toner-supporting member. In this alternative embodiment, the toner layer on the toner-supporting member is temporarily transferred to the intermediate roller, and then the toner on the intermediate roller is jettingly flied toward the recording medium.

The toner to be loaded into the aforementioned image-forming apparatus according to the present invention may be any of the publicly known toners provided that the opening ratio of each aperture is fallen within the aforementioned range when the toner is jettingly adhered to the recording medium 20 times. However, within the range of the opening ratio wherein a release property of the toner particles at the time of flying is not hindered as a mean roundness of the toner is too low, said opening ratio when the toner is jettingly adhered to the recording medium is increased if the mean roundness of the toner is set as a low value. Although the toner is frictionally charged by a regulating blade or the like (not shown in FIG. 2) which is arranged on the sleeve in a pressed state, it is thinkable that if the mean roundness of the toner is too high, a wrongly charged toner (WST) is increased to lower the opening ratio because the toner becomes apt to pass through the blade or the like, with the result that the toner is not frictionally charged to a sufficient extent. To put it concretely, although it is thinkable that the properly charged toner flies smoothly without changing the opening ration while the aforesaid balance is maintained, the wrongly charged toner is apt to adhere to an inner wall of the aperture because it has an opposite polarity to a proper polarity or an electrification amount which is less than the proper electrification amount and its response ability for a flight is low. It is thinkable that when the wrongly charged toner is adhered to the inner wall of the aperture, a probability that said toner will continue to exist on said inner wall becomes high, and the aforesaid balance is lost, with the result that the opening ratio will be lowered with an increase of the wrongly charged toner. From the viewpoints that a formation of the wrongly charged toner is suitably suppressed to maintain the aforementioned balance and that a sharp image can be obtained in an easier manner, it is desirable in the present invention to employ the toner having the mean roundness of 0.950-0.990, preferably 0.960-0.985.

In the present specification, the mean roundness is a mean value of the values calculated from the following equation:

$$Mean roundness = \frac{\begin{matrix}Circumferential length of a circle which is \\ equal to a projection area of a particle\end{matrix}}{\begin{matrix}Circumferential length of a projection image \\ of a particle\end{matrix}}$$

As the “circumferential length of a circle which is equal to a projection area of a particle” and “circumferential length of a projection image of a particle”, the values are used, said values being obtained by measuring said lengthes in the aqueous dispersion system by means of a flow-type particle image analyzer (FPIA-1000 or FPIA-2000; made by Toa Iyou Denshi K.K.). In the present invention, the mean roundness is not necessarily measured by means of the abovementioned analyzer. Any device may be adopted as long as the measurements are carried out based upon the abovementioned equation in principle.

Furthermore, the aforesaid opening ratio is increased when the volume-average particle size of the toner is set large within the range wherein there are no problems that the apertures are physically closed by the toner whose volume-average particle size is too large, and the like. Although the volume-average particle size of the toner cannot unconditionally be specified because the opening ratio is changed by suitably regulating the various setting conditions of the image-forming apparatus (e.g. electrical condition, mechanical condition, toner condition and the like of said apparatus) and because it is necessary to suitably set the volume-average particle size of the toner after consideration of the relationship between said particle size and a diameter of the aperture, it is preferable in the present invention to employ the toner having the volume-average particle size of 5.00-10.00 μm, preferably 6.50-8.00 μm from the viewpoint of an easier regulation of the opening ratio.

The toner used in the image-forming apparatus according to the present invention may be produced by any methods, for example, a grinding method, a wet method and the like.

For example, the toner used in the present invention can be obtained by sufficiently mixing at least a binder resin and a colorant and, if necessary, a wax and a charge-control agent, melt-kneading the mixture, cooling the kneaded mixture, subjecting the cooled mixture to coarsely and finely grinding treatments, and then the finely ground product is classified. Further, the toner used in the present invention may be prepared by a publicly known wet methods, for example, a granulation method based on an emulsion dispersion process, a suspension polymerization method, an emulsion polymerization method and the like. However, from the viewpoints of production cost and production facility, it is preferable to use the above-mentioned grinding method.

When the toner used in the present invention is produced by the grinding method, at least a binder resin and a colorant and, if necessary, a wax and a charge-control agent are firstly mixed and dispersed by means of a mixing machine, such as a ball mill, a twin-shell blender, Henschel mixer, a high-speed dissolver, an internal mixer, a screw extruder, a fall bag and the like. Next, the mixture is heated and kneaded by means of a press kneader, a twin extrusion kneader, a roller and the like. The obtained mixture is coarsely ground by means of a grinder, such as a hammer mill, a jet mill, a cutter mill, a roller mill and the like. Then, the coarsely ground particles are finely ground by means of a grinder, such as a jet mill, a high-speed rotary grinder and the like. The finely ground particles are classified into a desired particle size by means of a classifier, such as an air classifier, an airstream classifier and the like to obtain toner particles.

As the binder resin used for preparing the toner, the following binders may alone or jointly be used in consideration of fixing and developing properties of the toner: single polymers of styrene or substituted styrene, such as polystyrene, poly-p-chlorostyrene, polyvinyltoluene and the like; styrene copolymers, such as styrene-p-chlorostyrene copolymer, styrene-propylene copolymer, styrene-vinyltoluene copolymer, styrene-vinylnaphthalene copolymer, styrene-methyl acrylate copolymer, styrene-ethyl acrylate copolymer, styrene-propyl acrylate copolymer, styrene-butyl acrylate copolymer, styrene-octyl acrylate copolymer, styrene-methyl methacrylate copolymer, styrene-ethyl methacrylate copolymer, styrene-butyl methacrylate copolymer, styrene-α-chloromethyl methacrylate copolymer, styrene-acrylonitrile copolymer, styrene-vinyl methyl ketone copolymer, styrene-butadiene copolymer, styrene-isoprene copolymer, styrene-acrylonitrile-indene copolymer, styrene-maleic acid copolymer, styrene-maleate copolymers and the like; acrylic resins, such as polyacrylate, polymethyl methacrylate, polyethyl methacrylate, poly-n-butyl methacrylate, polyglycidyl methacrylate, fluorine-containing polyacrylate and the like; polyvinyl chloride, polyvinyl acetate, polyethylene, polypropylene, polyesters, polyurethane, polyamides, epoxy resins, polyol resins, polyvinyl butyrate, polyacrylic acid resin, rosin, modified rosins, terpene resin, phenol resin, urea resin, aliphatic or alicyclic hydrocarbon resins, aromatic petroleum resins, chlorinated paraffin, paraffin wax and the like.

As the colorant included in the toner, the following colorants may be selected in consideration of necessary color tone and durability as well as dispersibility to the selected binder resin and the like, but it is not restricted to them.

Any of the publicly known dyeing pigments, for example, carbon black (furnace black, ketchen black, lamp black, thermal black, channel black and the like), phthalocyanine-pigment, azo-pigment, monoazo-pigment, disazo-pigment, azomethine-pigment, quinacridone-pigment, perylene-pigment, anthra-pyrimidine-pigment, isoindolinone-pigment, thren-pigment, benzidine-pigment, naphthol-pigment, xanthene-pigment and the like, such as chrome yellow, azo lake, colcothar, titanium oxide, molybdate orange, ultramarine blue, phthalocyanine blue, aniline blue, phoron yellow, rhodamine 6G, lake, chalcooil blue, thioindico, chrome yellow, quinacridone, benzidine yellow, Hanza yellow G, rose bengal, triallylmethane and the like can alone or jointly be used. The amount of these colorants used is normally 1-30 parts by weight, preferably 3-20 parts by weight in relation to 100 parts by weight of the binder resin.

Various releasants can jointly be used in order to give a releasability to the toner. In particular, a wax may be added in order to increase an anti-offset property and the like of the toner. As such a wax, polyethylene wax, polypropylene wax, carnauba wax, rice wax, sazol wax, montan ester waxes, Fischer-Tropsch wax and the like are exemplified. In case of adding a wax, the content of the wax is preferably 0.5-5 parts by weight in relation to 100 parts by weight of the binder resin in order to obtain its addition effect without causing problems, such as a filming and the like. The abovementioned wax may be used alone or jointly. When the waxes are jointly used, their total contents may be within the range mentioned above.

As the electrification adjustor (charge-control agent) added to the toner, nigrosine dyes, alkoxylated amines, quaternary ammonium salts, alkyl amides, metallic complexes of azo dyes, tetraphenylboron derivatives, Zn salts of salicylic acid derivatives, metallic complexes of alkyl salicylates, metallic salts of higher fatty acids and the like are used in consideration of a color tone and an electrification amount of the toner. It is desirable that they are internally added in the range of 1-10 parts by weight, preferably 2-8 parts by weight in relation to 100 parts by weight of the binder resin. If less than 1 part by weight of the electrification adjustor is added internally, it becomes difficult to saturatedly electrify the toner uniformly and quickly, and the image density decreases to the lower value than the allowable density. If more than 10 parts by weight of the electrification adjustor is added internally, the electrification amount of the toner becomes excessive, and a fogging of the image exceeds the allowable level.

It is preferable to subject the toner used in the present invention to a surface treatment by means of a device for modifying a surface. The mean roundness of the toner can be controlled by the surface treatment. As the device for modifying a surface used for the surface treatment, the following equipments are exemplified: systems wherein a method for impacting a particle in a high-speed air flow is applied, such as Hybridization system (made by Nara Kikai Seisakusho K.K.), Cosmos system (made by Kawasaki Jukogyo K.K.), Inomizer system (made by Hosokawa Micron K.K.) and a Turbo Mill (made by Turbo Kogyo K.K.); systems wherein a dry mechanochemical method is applied, such as Mechanofusion system (made by Hosokawa Micron K.K.) and Mechano Mill (made by Okada Seiko K.K.); systems wherein a method for modifying a particle in a heated air flow is applied, such as Surfusing System (made by Nippon Pneumatic Kogyo K.K.) and Heat treatment apparatus (made by Hosokawa Micron K.K.); systems wherein a wet coating method is applied, such as Dispercoat (made by Nisshin Engineering K.K.) and Coatmizer (made by Freund Sangyo K.K.); and the like.

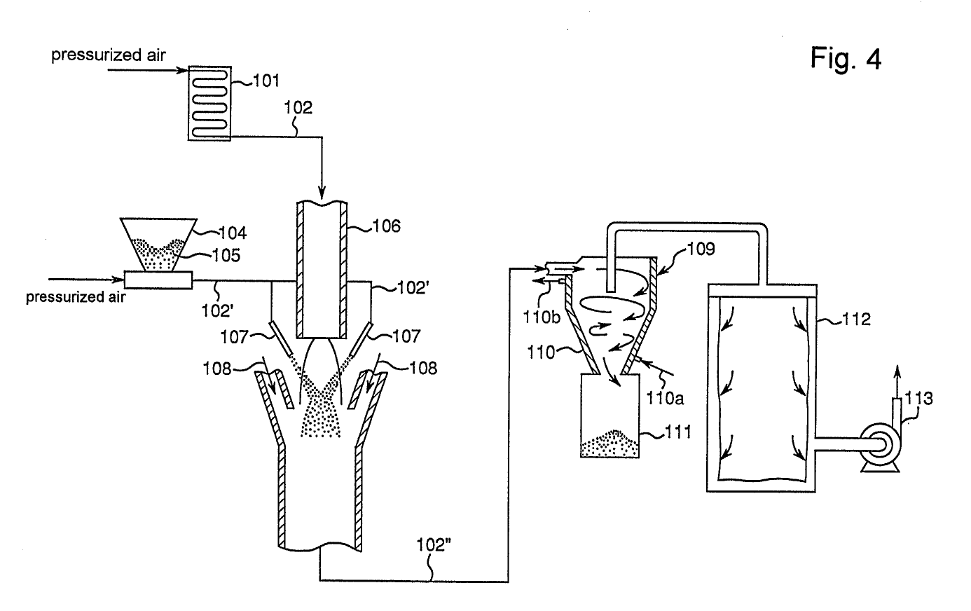

Among the abovementioned devices for modifying a surface, the Surfusing System (made by Nippon Pneumatic Kogyo K.K.) or the Heat treatment apparatus (made by Hosokawa Micron K.K.) is preferable to treat the toner used in the present invention since it can control the mean roundness of the toner while the toner is heat-treated. By subjecting the toner to the heat-treatment, a suitable surface smoothness of the toner can be obtained, and the objective of the present invention can be achieved more effectively. By referring to FIG. 4, the case where the heat treatment of the toner surface is carried out by means of the aforesaid Surfusing System will be explained hereinafter. As illustrated in FIG. 4, a high-temperature and high-pressure air generated in a heated air generator 101 is jetted from a jet nozzle for the heated air 106 through an introduction tube 102. A predetermined amount of toner particles (sample) 105 to be subjected to a surface-modifying treatment in a dispenser 104 is transported by an action of pressurized air through an introduction tube 102′, and jetted into the heated air from a jet nozzle for the sample 107 installed around the periphery of the jet nozzle for the heated air 106. In this case, it is preferable to provide a predetermined tilt to jet nozzle for the sample 107 with respect to the jet nozzle for the heated air 106 so as not to allow the jetted flow from the jet nozzle for the sample 107 to cross the heated air flow. The toner particles jetted in this manner are uniformly subjected to the surface-modifying treatment when they are instantaneously come in contact with the high-temperature air flow.

Next, the toner particles which have been subjected to the surface-modifying treatment are rapidly cooled down by a cold air flow that is introduced from an introduction section for the cold air flow 108. Such a rapid cooling prevents the toner particles from adhering to a wall of the device and from agglomerating the toner particles, said rapid cooling improving the yield of the toner. The modified toner particles are then collected into a cyclone 109 through an introduction tube 102″, and accumulated in a product tank 111. After the toner particles are collected, the transporting air from the cyclone 119 is induced to pass through a bagfilter 112 in which a fine powder is removed, and then discharged to the atmosphere through a blower 113. A cooling jacket 110, in which a cooling water (110a and 110b) is circulated, is installed in the cyclone 109 in order to prevent an agglomeration of the toner particles inside the cyclone by cooling said particles with the cooling water.

In the case where the surface-modifying treatment is carried out by using the above-mentioned device, the mean roundness of the toner can easily be controlled by a suitable fine adjustment of the device conditions, for example, a maximum treatment temperature, a residence time, a dispersion concentration of the powder, a temperature of the cooling air, a temperature of the cooling water and the like. In the present invention, it is preferable to set the treatment temperature within the range of from 150 to 300° C., as a general rule.

When the surface-modifying treatment is carried out in this manner in order to control the mean roundness of the toner, it is preferable to add an external additive to the toner prior to said treatment. By an addition of the external additive, the dispersibility of the toner particles in said treatment can be improved and a variability of shape of the toner particles can be controlled. A suitable addition amount of the external additive is 0.1-5% by weight relative to the toner. As the external additive, the aftermentioned post-treating agent can be used.

It is preferable to externally add the post-treating agent to the toner employed in the present invention. In the case where the toner has been subjected to the aforementioned surface treatment, it is preferable to externally add the post-treating agent to the surface-treated toner. The following fine particles are exemplified as the post-treating agent: silica fine particles (silicon dioxide, aluminum silicate, sodium silicate, potassium silicate, zinc silicate, magnesium silicate and the like), metallic oxide fine particles (titanium oxide, aluminum oxide, tin oxide, stibium oxide, zinc oxide, zirconium oxide, strontium titanate, barium titanate and the like) and the like. As the other post-treating agent, a cleaning auxiliary containing fine powder of a resin, such as polymetyl methacrylate and fluoropolymer (polyvinylidene fluoride, polytetrafluoroethylene), an anti-caking agent, a fixing auxiliary, such as polyolefins having a low molecular weight, or a lubricating agent for preventing a sticking of a developing blade, such as metallic salts of fatty acids (lead stearate, aluminum stearate and the like) may also be added. The abovementioned post-treating agents can be used alone or jointly. Further, these post-treating agents may previously be subjected to a surface treatment, such as a hydrophobicizing treatment.

It is desirable to use the post-treating agent in the ratio of 0.1-5% by weight, preferably 0.3-3% by weight relative to the toner. When two or more kinds of post-treating agents are used, it is desirable that the total amounts of the post-treating agents are fallen within the abovementioned range.

Although the publicly known mixer can be used as the means for mixing the post-treating agent, it is preferable to use, for example, a high-speed fluid mixer. As the high-speed fluid mixer, Henschel mixer, supermixer, micro-speed mixer and the like are exemplified. After the post-treating agent is added to and mixed with other ingredients of the toner, it is preferable to remove agglomerates and impurities by using a sieve.

By employing the abovementioned toner, the aforesaid opening ratio of the apertures can readily be controlled, and the object of the present invention can easily be achieved.

In the preferred embodiment of the image-forming apparatus according to the present invention, various setting conditions of said apparatus, such as the electrical condition, the mechanical condition, the toner condition and the like are suitably selected in such a manner that the opening ratio of the apertures when the toner is jettingly adhered to the recording medium 20 times is fallen within the aforementioned range.

As the electrical condition of the image-forming apparatus, the abovementioned voltage, such as V_{B1} of the toner-supporting member, Vbe of the back electrode, Vb and Vw of the trigger electrode, Vg and Vgw of the guarded electrode and the like are exemplified.

As the mechanical condition of the image-forming apparatus, the space (L1: see FIG. 5 which should be referred to the following parameters) between the sleeve and the head, the space (L2) between the back electrode roller and the head, the thickness (L3) of the head, the diameter (L4) of the aperture, the size (L5 and L5′) of the trigger electrode, the size (L6 and L6′) of the guarded electrode, the space (L7) between the trigger electrode and the guarded electrode in the direction of the thickness of the head and the like are exemplified.

As the toner condition, the volume mean particle size, the mean roundness, the electrification amount, the apparent aerated density (e.g. what is called AD value) and the like of the toner are exemplified.

That is to say, in the more preferred embodiment of the present invention, when, for example, the image-forming apparatus (V_{B1}=−100-100V; Vb=400-850V; Vw=−100-0V; Vgw=−100-50V; L4=60-140 μm) into which the negatively charged toner (the volume mean particle size=5.00-10.00 μm; the mean roundness=0.950-0.990) is loaded is employed, the voltage (Vbe) of the back electrode and the direct current voltage (Vg) of the guarded electrode outputted at the time of printing are set to 450-800V (preferably 550-750V) and 50-350V (preferably 100-200V) respectively. By suitably selecting the voltage Vbe and Vg within the aforementioned range, the opening ratio of the apertures when the toner is jettingly adhered to the recording medium 20 times can more easily set within the aforementioned range, and the object of the present invention can be achieved more effectively.

### EXAMPLES

Production Example of Polyester Resin A

Into a four-necked glass flask equipped with a thermometer, a stirrer, a reflux condenser and a tube for introducing a nitrogen gas, polyoxypropylene(2,2)-2,2-bis(4-hydroxyphenyl)propane, polyoxyethylene(2,2)-2,2-bis(4-hydroxyphenyl)propane, isododecenyl succinic anhydride, terephthalic acid and fumaric acid, a weight ratio of said components being adjusted to 82:77:16:32:30, together with dibutyltin oxide as a polymerization initiator were charged. The reaction was carried out at 220° C. by heating the mixture with a mantle heater under a nitrogen gas atmosphere while said mixture was stirred. A polyester resin A thus obtained had a softening point (Tm) of 110° C., a glass transition point (Tg) of 60° C. and an acid value of 17.5 KOH mg/g.

Production Example of Polyester Resin B

Styrene and 2-ethylhexyl acrylate were mixed in a weight ratio of 17:3.2, and the mixture was charged into a dropping funnel together with dicumylperoxide as a polymerization initiator. Into a four-neck glass flask equipped with a thermometer, a stirrer, a reflux condenser and a tube for introducing a nitrogen gas, polyoxypropylene(2,2)-2,2-bis(4-hydroxyphenyl)propane, polyoxyethylene(2,2)-2,2-bis(4-hydroxyphenyl)propane, isododecenyl succinic anhydride, terephthalic acid, 1,2,4-benzenetricarboxylic acid anhydride and acrylic acid, a weight ratio of said components being adjusted to 42:11:11:11:8:1, together with dibutyltin oxide as a polymerization initiator were charged. This flask was placed in a mantle heater, and styrene and said acrylate were dropped into the flask from the dropping funnel while the mixture was stirred at 135° C. under a nitrogen gas atmosphere, and then the mixture was heated to 230° C. at which the reaction was carried out. A polyester resin B thus obtained had a softening point of 150° C., a glass transition point of 62° C. and an acid value of 24.5 KOH mg/g.

Preparation of Toner 1

Forty parts by weight of polyester resin A, 60 parts by weight of polyester resin B, 2 parts by weight of polyethylene wax (800P; made by Mitsui Sekiyu Kagaku Kogyo K.K.), 2 parts by weight of polypropylene wax (TS-200; made by Sanyo Kasei Kogyo K.K.), 8 parts by weight of acid carbon black (Mogul-L; made by Cabot K.K.; pH 2.5; average primary particle size: 24 nm) and 2 parts by weight of a negative charge-control agent represented by the following formula (I):

[chemical structure]

were sufficiently mixed by Henschel Mixer, and melted and kneaded by a twin extrusion kneader. The kneaded mixture was cooled, coarsely ground by a hammer mill, and finely pulverized by a jet pulverizer, and then classified to obtain toner particles. The toner particles obtained were subjected to the surface treatment by means of the device for modifying a surface shown in FIG. 4 (the Surfusing System made by Nippon Pneumatic Kogyo K.K.).

To these toner particles were added 0.5% by weight of hydrophobic silica (TS-500; made by Cabot K.K) and 1% by weight of titanium oxide (STT30A; made by Titan Kokyo K.K), and the obtained mixture was treated by means of a vibrating sieve (sieve opening: 106 μm) to obtain toner 1. The toner 1 has the volume-average particle size of 7.36 μm and the mean roundness of 0.970.

Preparation of Toners 2 and 3

The toners 2 and 3 were obtained by the same manner as in the case of preparing the toner except that the grinding condition and classifying condition were changed and the surface treatment was omitted. The toner 2 has the volume-average particles size of 6.65 μm and the mean roundness of 0.953. The toner 3 has the volume-average particle size of 7.95 μm and the mean roundness of 0.954.

### EXAMPLES 1.1-3.4

The toners described in Table 1 were loaded into the image-forming apparatus having the structure shown in FIG. 1 and FIG. 2 wherein the voltage Vg and Vbe were set as described in Table 1, and said apparatus was operated under the conditions described hereinafter. And an evaluation of the toners was carried out according to the method as described below.

The main setting conditions of the image-forming apparatus are as follows:

Electrical Conditions

(1) Trigger electrode (pulse period: 850 sec; voltage (Vb) when the toner is flied: 600V (black); time for applying the voltage Vb: 300 ms; voltage (Vw) when the toner is not flied: −10V (white): time for applying the voltage Vw: 550 ms)

(2) Guarded electrode (pulse period: synchronous with the trigger electrode; voltage (Vg) when the toner is flied: see Table 1; voltage (Vgw) when the toner is not flied: 0V)

(3) Voltage (V_{B1}) of the developing roller: 0V

(4) Voltage (Vbe) of the back electrode: see Table 1

Mechanical Conditions (see FIG. 5)

L1=20 μm, L2=200 μ, L3=100 μm, L4=100 μm, L5=130 μm, L5′=210 ↑m, L6=180 μm, L6′=260 μm, L7=50 μm,

Opening Ratio

The opening ratio used in the present specification means an average value of the measured opening ratios of arbitrary thirteen apertures.

Clogging

The printing of a black solid image was carried out 100 times by using A-4 size papers in a lengthwise state. A clogging was graded on the following criteria.

“O”: No white stripe was occurred on all images.

“Δ”: A white stripe was occurred after the printing was carried out 50-99 times.

“x”: A white stripe was occurred after the printing was carried out 1-49 times.

Sharpness of an Edge

Ten linear images which is parallel to a moving direction of a paper were formed by using the same aperture. Sharpness of an edge was graded on the following criteria.

“O”: All linear images had a rank of not less than 6, and a boundary (edge) was distinctly recognized with a naked eye, and was preferable.

“Δ”: All linear images had a rank of not less than 4.5, and a boundary was recognized with a naked eye, and there was no practical problem.

“x”: There were linear images having a rank of less than 4.5 whose boundary was foggy, said images coming into question from a practical viewpoint.

The rank is a measure which indicates a sharpness of the boundary between the image and the substrate on the paper. The larger the rank is, the sharper the boundary is. The rank was determined by the following method.

An enlarged view of the linear image obtained (A half-band width of Gauss function is regarded as a width of a line.) was digitized by means of a digital microscope VF-6300 (made by Keyence Co.)(magnification: 175). A shading correction (angle correction) of the digitized image obtained was carried out, and then a brightness profile of the line was measured (The image-treating soft “Image Pro Plus” was used). The brightness profile was approximated to Gauss function, and the half-band width of Gauss function (Wh) and a difference of maximum brightness (max) and minimum brightness (min) were determined. The rank was determined by the following equation:

Rank=6 log[(max−min)/Wh]+3.885

The results obtained are shown in Table 1.

TABLE 1

| | | particle | | | | | | | |
|---|---|---|---|---|---|---|---|---|---|
| | | size | mean | Vg | Vbe | opening | | sharpness | amount of |
| | toner | (μm) | roundness | (V) | (V) | ratio (%) | clogging | of edge | WST |
| Ex. 1.1 | 1 | 7.36 | 0.970 | +100 | 450 | 38 | X | ∘ | 31.1 |
| Ex. 1.2 | 1 | 7.36 | 0.970 | +100 | 800 | 31 | X | ∘ | 31.1 |
| Ex. 1.3 | 1 | 7.36 | 0.970 | +200 | 450 | 54 | Δ | ∘ | 31.1 |
| Ex. 1.4 | 1 | 7.36 | 0.970 | +200 | 800 | 41 | Δ | ∘ | 31.1 |
| Ex. 1.5 | 1 | 7.36 | 0.970 | +300 | 600 | 61 | ∘ | ∘ | 31.1 |
| Ex. 1.6 | 1 | 7.36 | 0.970 | +300 | 800 | 55 | Δ | ∘ | 31.1 |
| Ex. 2.1 | 2 | 6.65 | 0.953 | +100 | 450 | 68 | ∘ | ∘ | 5.1 |
| Ex. 2.2 | 2 | 6.65 | 0.953 | +100 | 800 | 60 | ∘ | ∘ | 5.1 |
| Ex. 2.3 | 2 | 6.65 | 0.953 | +300 | 600 | 89 | ∘ | ∘ | 5.1 |
| Ex. 2.4 | 2 | 6.65 | 0.953 | +300 | 800 | 82 | ∘ | ∘ | 5.1 |
| Ex. 3.1 | 3 | 7.95 | 0.954 | +100 | 450 | 77 | ∘ | ∘ | 4.5 |
| Ex. 3.2 | 3 | 7.95 | 0.954 | +100 | 800 | 74 | ∘ | ∘ | 4.5 |
| Ex. 3.3 | 3 | 7.95 | 0.954 | +300 | 600 | 98 | ∘ | X | 4.5 |
| Ex. 3.4 | 3 | 7.95 | 0.954 | +300 | 800 | 95 | ∘ | Δ | 4.5 |

The volume-average particle size and the mean roundness of the toner, and amount of wrongly charged toner used in the present specification are the values which were measured by the following methods.

The volume-average particle size of the toner was measured by means of Coulter counter MULTISIZER (made by Coulter Co.).

The mean roundness of the toner was measured in the aqueous dispersion system by means of the flow-type particle image analyzer FPIA-2000 (made by Toa Iyou Denshi K.K.).

The amount of wrongly charged toner (WST) was obtained by measuring a distribution of electrification amount by means of E-SPART ANALYZER (made by Hosokawa Micron K.K.). The measurement of the distribution of electification amount was carried out by using a toner layer formed on the toner-supporting member under each condition. The wrongly charged toner means a positively charged toner.

The image-forming apparatus according to the present invention does not cause the clogging of the apertures for a long time and supplies a sharp image.

What is claimed is:

1. An image-forming apparatus which comprises
(i) a toner-supporting member which supports and conveys a toner,
(ii) a back electrode which is arranged on the opposite side of the toner-supporting member at a predetermined interval,
(iii) a head equipped with a plural aperture and a recording electrode which is arranged in such a way that it surrounds each aperture, said head being arranged between the toner-supporting member and the back electrode, and
(iv) a driver which applies a voltage to the recording electrode in response to an image signal and which causes the toner supported on the toner-supporting member to adhere jettingly to a recording medium through the apertures,
wherein an opening ratio of the apertures is 40-95% when the toner is jettingly adhered to the recording medium 20 times.

2. An apparatus of claim 1, wherein the opening ratio is 60-90%.

3. An apparatus of claim 1, wherein the opening ratio is 70-90%.

4. An apparatus of claim 1, wherein a diameter of the apertures is 60-140 μm.

5. An apparatus of claim 1, wherein the diameter of the apertures is 70-120 μm.

6. An apparatus of claim 1, wherein the diameter of the apertures is 80-100 μm.

7. An apparatus of claim 1, wherein the voltage applied to the back electrode has an opposite polarity to the toner, and an absolute value of the voltage is 450-800V.

8. An apparatus of claim 7, wherein the absolute value of the voltage applied to the back electrode is 550-750V.

9. An apparatus of claim 7, wherein a voltage applied to the recording electrode when the toner flies jettingly has an opposite polarity to the toner, and an absolute value of the voltage is 400-850V.

10. An apparatus of claim 9, wherein the absolute value of the voltage applied to the recording electrode is 550-750V.

11. An apparatus of claim 9, wherein a voltage applied to the recording electrode when the toner does not fly jettingly has the same polarity as the toner or is 0V, and the absolute value of the voltage is 0-100V.

12. An apparatus of claim 11, wherein the absolute value of the voltage applied to the recording electrode is 0-50V.

13. An apparatus of claim 1, wherein the toner is a non-magnetic toner.

14. An apparatus of claim 13, wherein the toner has a mean roundness of 0.950-0.990.

15. An apparatus of claim 13, wherein the toner has a volume-average particle size of 5-10 μm.

16. An image-forming apparatus which comprises
(i) a toner-supporting member which supports and conveys a toner,
(ii) a back electrode which is arranged on the opposite side of the toner-supporting member at a predetermined interval,
(iii) a head equipped with a plural aperture and a recording electrode which is arranged in such a way that it surrounds each aperture, said head being arranged between the toner-supporting member and the back electrode, and
(iv) a driver which applies a voltage to the recording electrode in response to an image signal and which causes the toner supported on the toner-supporting member to adhere jettingly to a recording medium through the apertures,
wherein an opening ratio of the apertures is 40-95% when the toner is jettingly adhered to the recording medium 20 times by applying a voltage which has an opposite polarity to the toner and an absolute value of 400-850V to the recording electrode under the condition that a voltage which has an opposite polarity to the toner and an absolute value of 450-800V is applied to the back electrode.

17. An apparatus of claim 16, wherein the opening ratio is 60-90%.

18. An apparatus of claim 16, wherein a diameter of the apertures is 60-140 μm.

19. An apparatus of claim 16, wherein the toner has a mean roundness of 0.950-0.990 and a volume-average particle size of 5-10 μm.

20. An apparatus of claim 16, wherein the toner has a mean roundness of 0.960-0.985 and a volume-average particle size of 5-8 μm.
